(19) United States
(12) Patent Application Publication
(10) Pub. No.: US 2003/0191761 A1
(43) Pub. Date: Oct. 9, 2003

(54) Methods and apparatus for remote file access

(75) Inventor: John Linus Bauer, Hanska, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 10/116,334

(22) Filed: Apr. 4, 2002

(51) Int. Cl. G06F 17/30; G06F 7/00

(52) U.S. Cl. 707/10

(57) ABSTRACT

In a first aspect, a first computer stores a first application program, a remote data access program module and a first operating system program. A second computer stores a server application program and a second operating system program. A data communication channel connects the first computer to the second computer. A file access command that is applicable to a data file stored at the second computer is issued from the application program at the first computer. The file access command is transmitted from the remote data access program module to the server application program via the first and second operating system programs. The server application program executes the file access command with respect to the data file stored at the second computer by means of a suitable call to the second operating system program. The file access command may be a write command or a read command.

### FIELD OF THE INVENTION

The present invention is concerned with computer systems, and is more particularly concerned with transfer of data between two computers.

### BACKGROUND OF THE INVENTION

A prior art technique for transferring files from one computer to another is schematically illustrated in FIG. 1. FIG. 1 shows a host computer 10, and a client computer 12 connected to the host computer 10 via a data communication channel 14. An operating system program 16 is stored in the host computer 10, and an operating system program 18 is stored in the client computer 12. In the particular prior art arrangement shown in FIG. 1, it is assumed that both of the operating system programs 16 and 18 are the well-known AIX operating system, which is derived from Unix, and may include a portion referred to as “NFS”, which stands for “Network File System”. Reference numeral 20 indicates the NFS portions of the operating systems 16, 18. As is familiar to those who are skilled in the art, NFS handles transfer of files between computers.

It is further assumed with respect to the arrangement shown in FIG. 1 that the client computer 12 stores an application program 22 that needs to access a file or files stored in a file system 24 associated with the host computer 10. To obtain access to a file at the host computer 10, the application program 22 makes suitable program calls to the NFS portion 20 of the client operating system program 18. The NFS portion 20 of the client operating system program 18 cooperates with the NFS portion 20 of the host operating system program 16 to handle transfers of data between the host computer 10 and the client computer 12 via the data communication channel 14.

While the prior art software arrangement illustrated in FIG. 1 works satisfactorily in many cases, it would sometimes be desirable to obtain higher data transfer rates than have proven to be possible using NFS or to access data when NFS is not present on one or both of the host and the client.

### SUMMARY OF THE INVENTION

According to a first aspect of the invention, there is provided a method of using a first computer to access data stored in a second computer that is connected to the first computer via a data communication channel. The inventive method includes issuing a write command from an application program at the first computer, where the write command is applicable to a data file stored at the second computer. The inventive method further includes transmitting the write command to an application program at the second computer, and executing the write command with respect to the data file stored at the second computer.

In at least one embodiment, the transmitting step may include passing the write command to an operating system program at the first computer as part of a socket send call, transmitting a socket message including the write command from the operating system program at the first computer to an operating system program at the second computer, and passing the write command from the operating system program at the second computer to the application program at the second computer. The executing step may include executing a call from the application program at the second computer to the operating system program at the second computer.

According to a second aspect of the invention a method includes issuing a read command from an application program at a first computer, where the read command is applicable to a selected portion of a data file stored at a second computer. The method according to this aspect of the invention further includes transmitting the read command to an application program at the second computer, and executing the read command with respect to the selected portion of the data file stored at the second computer.

According to a third aspect of the invention, a method includes issuing an open file command from an application program at a first computer, where the open file command is applicable to a data file stored at a second computer. The method according to this aspect of the invention further includes transmitting the open file command to an application program at the second computer, and executing the open file command with respect to the data file stored at the second computer.

According to a fourth aspect of the invention, a method includes issuing a close file command from an application program at a first computer, where the close file command is applicable to a data file stored at a second computer. The method according to this aspect of the invention further includes transmitting the close file command to an application program at the second computer, and executing the close file command with respect to the data file stored at the second computer.

According to a fifth aspect of the invention, an apparatus includes a first computer storing an application program, a remote data access program module and a first operating system program; a second computer storing a server application program and a second operating system program; and a data communication channel connecting the first computer to the second computer. Further in accordance with this aspect of the invention, the application program is operative to issue a write command that is applicable to a data file stored at the second computer; the remote data access program module is operative to transmit the write command to the server application program via the first and second operating system programs; and the server application program is operative to execute the write command with respect to the data file stored at the second computer.

According to a sixth aspect of the invention, an apparatus includes a first computer storing an application program, a remote data access program module and a first operating system program; a second computer storing a server application program and a second operating system program; and a data communication channel connecting the first computer to the second computer. Further in accordance with this aspect of the invention, the application program is operative to issue a read command that is applicable to a selected portion of a data file stored at the second computer, the remote data access program module is operative to transmit the read command to the server application program via the first and second operating system programs; and the server application program is operative to execute the read command with respect to the selected portion of the data file stored at the second computer.

According to a seventh aspect of the invention, an apparatus includes a first computer storing an application program, a remote data access program module and a first operating system program; a second computer storing a server application program and a second operating system program; and a data communication channel connecting the first computer to the second computer. Further in accordance with this aspect of the invention, the application program is operative to issue an open file command that is applicable to a data file stored at the second computer; the remote data access program module is operative to transmit the open file command to the server application program via the first and second operating system programs; and the server application program is operative to execute the open file command with respect to the data file stored at the second computer.

According to an eighth aspect of the invention, an apparatus includes a first computer storing an application program, a remote data access program module and a first operating system program; a second computer storing a server application program and a second operating system program; and a data communication channel connecting the first computer to the second computer. Further in accordance with this aspect of the invention, the application program is operative to issue a close file command that is applicable to a data file stored at the second computer; the remote data access program module is operative to transmit the close file command to the server application program via the first and second operating system programs; and the server application program is operative to execute the close file command with respect to the data file stored at the second computer.

Numerous other aspects are provided, as are computer program products. Each inventive computer program product may be carried by a medium readable by a computer (e.g., a carrier wave signal, a floppy disk, a hard drive, a random access memory, etc.).

With the methods and apparatus of the present invention, it may be possible to achieve data transfers between remotely located computers at a higher data transfer rate than is provided by prior art file transfer arrangements.

Other objects, features and advantages of the present invention will become more fully apparent from the following detailed description of exemplary embodiments, the appended claims and the accompanying drawings.

### BRIEF DESCRIPTION OF THE DRAWINGS

FIG. 1 is a block diagram illustrating a conventional arrangement for effecting file transfers between remote computers;

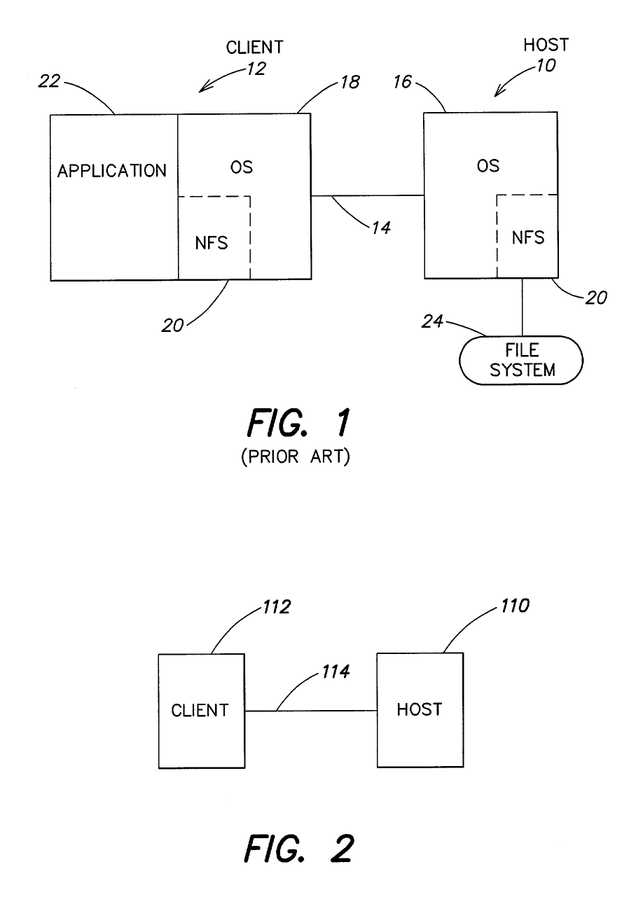

FIG. 2 is a block diagram of interconnected remote computers provided in accordance with the invention;

FIG. 3 schematically illustrates a structure of software stored in accordance with the invention in the computers of FIG. 2; and

FIGS. 4A and 4B diagrammatically illustrate operation of file transfer software provided in accordance with the invention in the computers of FIG. 2.

### DETAILED DESCRIPTION

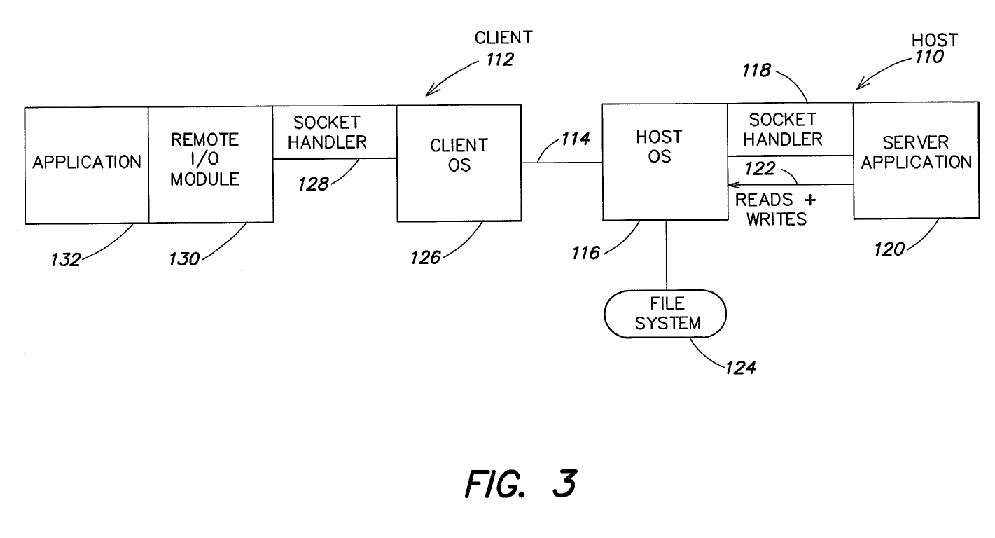

The present invention will now be described with reference to FIGS. 2-4.

FIG. 2 shows a host computer 110 connected to a client computer 112 via a data communication channel 114. The host computer 110 and the client computer 112 may be, for example, RS-6000 computers available from International Business Machines Corporation, the assignee of the present invention. Alternatively, the host computer 110 and the client computer 112 may be based on Intel processors operating with the Linux operating system or may be any type of Unix systems. Any other suitable computer and/or operating systems may be employed. It is not necessary that the host computer 110 be of the same type as the client computer 112. It is also not necessary that the host computer 110 be operated with the same type of operating system as the client computer 112.

The data communication channel may be, for example, a gigabit Ethernet connection, but may alternatively be any other type of data communication channel.

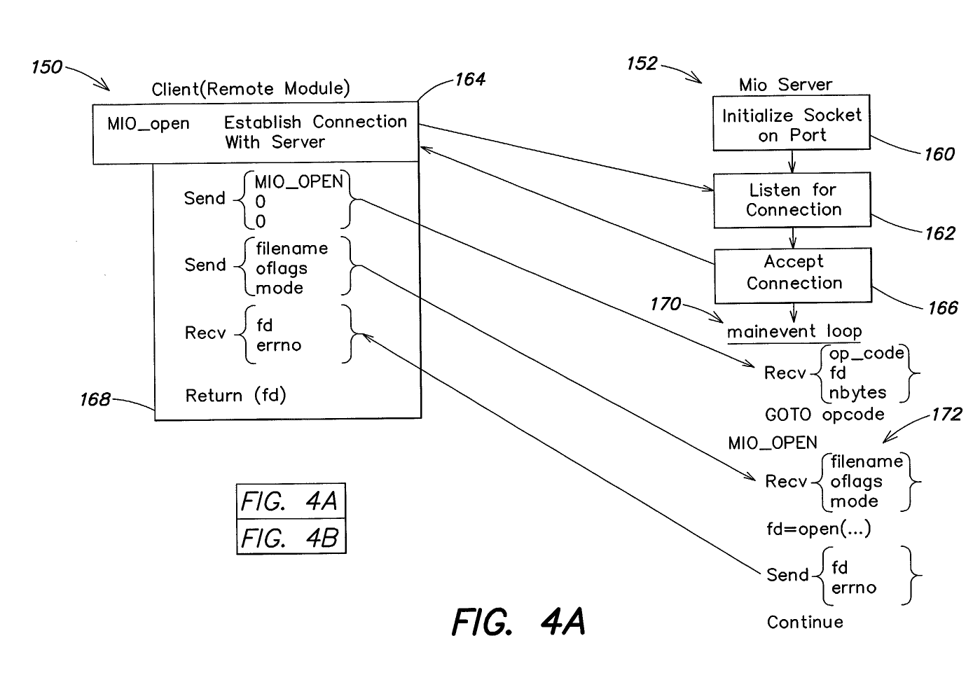

FIG. 3 schematically illustrates software which controls the host computer 110 and the client computer 112 to implement the present invention.

The host computer 110 stores a first operating system program 116, which may be a conventional operating system such as one of the operating systems referred to in connection with FIG. 2. The host system 110 also stores conventional socket handling software 118 which may, for example, be software which implements TCP/IP sockets.

The host computer 110 also stores a server application program 120 which is provided in accordance with the invention to handle file access commands that originate from the client computer 112. The host computer also stores data files in conjunction with a conventional file system 124 that is managed by the first operating system program 116. As indicated by arrow 122 in FIG. 3, the server application program 120 calls appropriate subroutines of the host operating system 116 to implement read and write commands which originate from the client computer 112.

The client computer 112 stores a second operating system program 126 which may also be any one of the types of operating system referred in connection with FIG. 2, and which may or may not be of the same type as the first operating system program 116.

The client computer 112 also includes conventional socket handling software 128, which is of a type to cooperate with the socket handling software 118 of the host computer 110. Thus, the socket handling software 128 may also be of the type which implements TCP/IP sockets.

Also stored in the client computer 112 is a remote I/O (input/output) module 130, which is provided in accordance with the invention and which functions as a remote data access program.

The client computer 112 also stores an application program 132. The application program 132 may generally be a conventional program, except that it is written to invoke remote data access functions of the remote I/O module 130. The remote I/O module 130 may be one of a library of I/O modules, which may include, for example, a “trace” module that logs input/output traffic and a “caching” module which handles prefetching of data. The application program 132 may be written so as to invoke one or more other modules of the modular I/O library in addition to the remote I/O module 130. The application program 132 may operate to allow a user to control file transfers to and from the host computer 110 in real time.

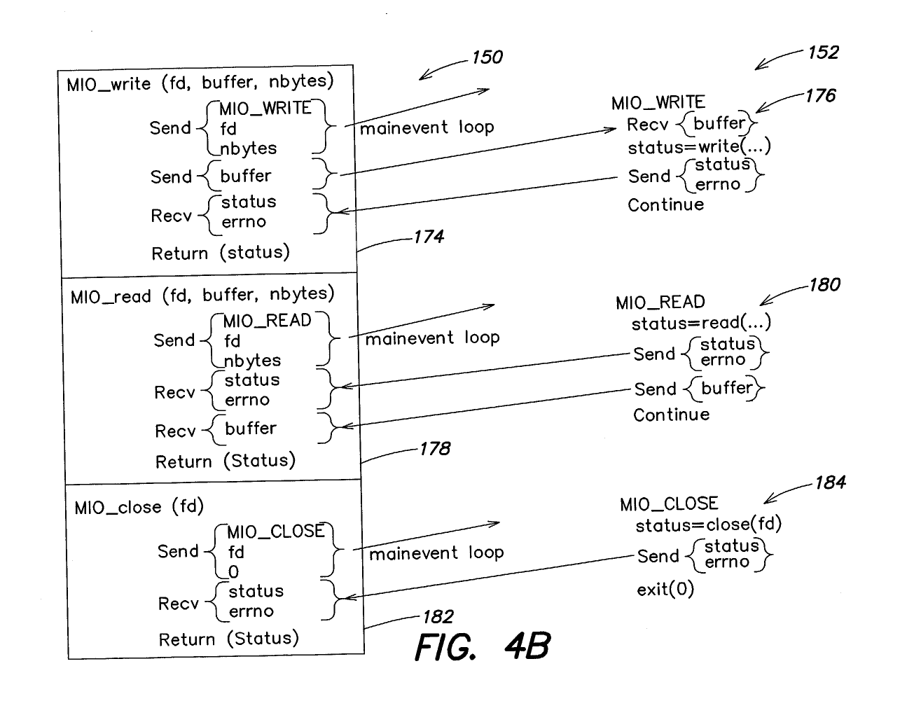

FIGS. 4A and 4B together schematically illustrate operation of the remote I/O module 130 and the server application program 120, and interaction therebetween. In FIGS. 4A and 4B, a left-hand column 150 indicates operation of the remote I/O module 130, and a right-hand column 152 indicates operation of the server application program 120.

Referring initially to the right-hand column 152 in FIG. 4A, the server application program 120 operates through the socket handling software 118 and the first operating system program 116 to initialize a socket on a port (not shown) of the host computer 110 (block 160). The server application program 120 then awaits a request for a connection (block 162). In the left-hand column 150 in FIG. 4A, the remote I/O module 130 initiates an open file procedure (block 164) in response to an open file command issued from the application program 132. In block 164 the remote I/O module 130 requests a connection with the host computer 110 and engages in a handshaking protocol with the server application program 120. The activity of the server application program 120 in terms of accepting the request for a connection and engaging in handshaking with the remote I/O module 130 is represented by block 166.

The balance of the procedure of remote I/O module 130 for handling an open file command is represented at block 168. The procedure of block 168 begins with sending a suitable op_code (“MIO_OPEN”) to the server application 120. The sending of the op_code proceeds from the remote I/O module 130 through the socket handling software 128, the second operating system program 126, the data communication channel 114, the first operating system program 116, and the socket handling software 118 to the server application program 120. At the server application program 120 the op_code is handled at a mainevent loop 170, and invokes an open file routine 172 of the server application program 120.

The open file procedure 168 continues as the remote I/O module 130 sends to the server application program 120 parameters such as a description of the file to be opened (“filename”), flags (“oflags”) indicative of states such as read only, write only, read-write, and a “mode” parameter for setting permission levels. These parameters are received by the open file routine 172 of the server application program 120 and the appropriate file is opened, via a suitable call to the first operating system program 116. The open file routine 172 of the server application program 120 then sends a file descriptor (“fd”) and an error number (which will be null if there is no error) to the open file procedure 168 of the remote I/O module 130. The open file procedure 168 of the remote I/O module 130 receives the file descriptor and error number and issues a suitable return, including the file descriptor, to the application program 132.

Turning to FIG. 4B, block 174 in the left-hand column 150 represents a procedure of the remote I/O module 130 that is invoked by a write command issued from the application program 132. Initially the procedure 174 issues a suitable op_code (“MIO_WRITE”) and suitable parameters (file descriptor and number of bytes to be written) to the server application program 120 via the socket handling software 128, the second operating system program 126, the data communication channel 114, the first operating system program 116 and the socket handling software 118. The op_code and accompanying parameters are initially received at the mainevent loop 170 (FIG. 4A) and then the appropriate routine of the server application program 120 (represented at 176 in FIG. 4B) is invoked. The write procedure 174 of the remote I/O module 130 next sends contents of a buffer containing the data to be written and this data is received by the write routine 176 of the server application program 120. The write routine 176 of the server application program 120 then causes the desired write operation to be performed through an appropriate call to the first operating system program 116. Then the write routine 176 of the server application program 120 sends a status message to the write procedure 174 of the remote I/O module 130, which receives the status message and issues a suitable return including the status to the application program 132.

Block 178 in the left-hand column 150 of FIG. 4B represents a procedure of the remote I/O module 130 that is invoked by a read command issued from the application program 132. The read command issued by application program 132 may specify a particular portion that is to be read from a file that has been opened at the host computer 110.

Initially in the read procedure 178 of the remote I/O module 130 a suitable op_code (“MIO_READ”) is sent to the server application program 120 with associated parameters (file descriptor and number of bytes to be read). The op_code and accompanying parameters are sent to the server application program 120 via the socket handling software 128, the second operating system program 126, the data communication channel 114, the first operating system program 116 and the socket handling software 118. The op_code is received at the mainevent loop 170 (FIG. 4a) of the server application program 120 and the corresponding routine 180 (FIG. 4B) is invoked. The routine 180 implements a read operation by means of a suitable call to the first operating system program 116. The read operation may read only a particular portion of the data file, as specified by the read command issued by the application program 132. The routine 180 then sends to the remote I/O module 130 a status message which is received by the procedure 178 of the remote I/O module 130.

The routine 180 of the server application program 120 then sends to the remote I/O module 130 the contents of a buffer which contains the data read through the read operation implemented via the first operating system program 116. The data is received by the read procedure 178 of the remote I/O module 130, which sends a suitable return message to the application program 132.

Block 182 in the right-hand column 150 of FIG. 4B represents a procedure that in invoked by a close file command issued from the application program 132. Initially in block 182 the remote I/O module 130 sends to the server application program 128 a suitable op_code (“MIO_CLOSE”) along with an associated parameter (file descriptor). The op_code is transmitted from the remote I/O module 130 to the server application program 120 via the socket handling software 128, the second operating system program 126, the data communication channel 114, the first operating system program 116 and the socket handling software 118. The op_code is received by the mainevent loop 170 of the server application program 120, and the corresponding routine 184 (FIG. 4B) is invoked.

In the close file routine 184 of the server application program 120, a close file operation is implemented by means of a suitable call to the first operating system program 116. The close file routine 184 then sends a status message to the remote I/O module 130. The close file procedure 182 of the remote I/O module 130 receives the status message and issues an appropriate return message to the application program 132.

With the software arrangement of the present invention, data transfer rates in excess of 40 megabytes per second have been achieved for transfers between the host computer 110 and the client computer 112. This compares to transfer rates of less than one megabyte per second which may be experienced using NFS in regard to files that are larger than the buffer capacity on the client side with NFS. In addition to avoiding bottlenecks due to buffer size in NFS, the present invention also streamlines operating system activity in regard to handshaking and the like that would be required using NFS. Moreover, implementation of the present invention does not require any modification of the operating systems at the host and client computers.

The foregoing description discloses only exemplary embodiments of the invention; modifications of the above disclosed apparatus and methods which fall within the scope of the invention will be readily apparent to those of ordinary skill in the art. For example, the client computer 112 may be temporarily or permanently connected to more than one host computer for transfers of data between the client computer 112 and the host computers in accordance with the invention. Similarly, the host computer 110 may be temporarily or permanently connected to more than one client computer for transfers of data between the host computer 110 and the client computers in accordance with the invention.

Furthermore, the data communication channel 114 between the host computer 110 and the client computer 112 need not be a gigabit Ethernet connection, but may instead be any other type of data communication channel.

Accordingly, while the present invention has been disclosed in connection with exemplary embodiments thereof, it should be understood that other embodiments may fall within the spirit and scope of the invention, as defined by the following claims.

The invention claimed is:

1. A method of using a first computer to access data stored in a second computer that is connected to the first computer via a data communication channel, the method comprising:
issuing a write command from an application program at the first computer, the write command being applicable to a data file stored at the second computer;
transmitting the write command to an application program at the second computer; and
executing the write command with respect to the data file stored at the second computer.

2. The method of claim 1, wherein the transmitting step includes:
passing the write command to an operating system program at the first computer as part of a socket send call;
transmitting a socket message including the write command from the operating system program at the first computer to an operating system program at the second computer; and
passing the write command from the operating system program at the second computer to the application program at the second computer.

3. The method of claim 2, wherein the executing step includes executing a call from the application program at the second computer to the operating system program at the second computer.

4. A method of using a first computer to access data stored in a second computer that is connected to the first computer via a data communication channel, the method comprising:
issuing from an application program at the first computer a command to read a selected portion of a data file stored at the second computer;
transmitting the command to an application program at the second computer; and
executing the command with respect to the selected portion of the data file stored at the second computer.

5. The method of claim 4, wherein the command issued from the application program at the first computer specifies the selected portion of the data file stored at the second computer.

6. The method of claim 4, wherein the transmitting step includes:
passing the command to an operating system program at the first computer as part of a socket send call;
transmitting a socket message including the command from the operating system program at the first computer to an operating system program at the second computer; and
passing the command from the operating system program at the second computer to the application program at the second computer.

7. The method of claim 6, wherein the executing step includes executing a call from the application program at the second computer to the operating system program at the second computer.

8. A method of using a first computer to access data stored in a second computer that is connected to the first computer via a data communication channel, the method comprising:
issuing an open file command from an application program at the first computer, the open file command being applicable to a data file stored at the second computer;
transmitting the open file command to an application program at the second computer; and
executing the open file command with respect to the data file stored at the second computer.

9. The method of claim 8, wherein the transmitting step includes:
passing the open file command to an operating system program at the first computer as part of a socket send call;
transmitting a socket message including the open file command from the operating system program at the first computer to an operating system program at the second computer; and
passing the open file command from the operating system program at the second computer to the application program at the second computer.

10. The method of claim 9, wherein the executing step includes executing a call from the application program at the second computer to the operating system program at the second computer.

11. A method of using a first computer to access data stored in a second computer that is connected to the first computer via a data communication channel, the method comprising:
issuing a close file command from an application program at the first computer, the close file command being applicable to a data file stored at the second computer;
transmitting the close file command to an application program at the second computer; and
executing the close file command with respect to the data file stored at the second computer.

12. The method of claim 11, wherein the transmitting step includes:
passing the close file command to an operating system program at the first computer as part of a socket send call;
transmitting a socket message including the close file command from the operating system program at the first computer to an operating system program at the second computer; and
passing the close file command from the operating system program at the second computer to the application program at the second computer.

13. The method of claim 12, wherein the executing step includes executing a call from the application program at the second computer to the operating system program at the second computer.

14. An apparatus comprising:
a first computer storing a first application program, a remote data access program module and a first operating system program;
a second computer storing a server application program and a second operating system program; and
a data communication channel connecting the first computer to the second computer;
wherein:
the first application program is operative to issue a write command that is applicable to a data file stored at the second computer;
the remote data access program module is operative to transmit the write command to the server application program via the first and second operating system programs; and
the server application program is operative to execute the write command with respect to the data file stored at the second computer.

15. An apparatus comprising:
a first computer storing a first application program, a remote data access program module and a first operating system program;
a second computer storing a server application program and a second operating system program; and
a data communication channel connecting the first computer to the second computer;
wherein:
the first application program is operative to issue a command to read a selected portion of a data file stored at the second computer;
the remote data access program is operative to transmit the command to the server application program via the first and second operating system programs; and
the server application program is operative to execute the command with respect to the selected portion of the data file stored at the second computer.

16. The apparatus of claim 15, wherein the command issued from the first application program specifies the selected portion of the data file stored at the second computer.

17. An apparatus comprising:
a first computer storing a first application program, a remote data access program module and a first operating system program;
a second computer storing a server application program and a second operating system program; and
a data communication channel connecting the first computer to the second computer;
wherein:
the first application program is operative to issue an open file command that is applicable to a data file stored at the second computer;
the remote data access program module is operative to transmit the open file command to the server application program via the first and second operating system programs; and
the server application program is operative to execute the open file command with respect to the data file stored at the second computer.

18. An apparatus comprising:
a first computer storing a first application program, a remote data access program module and a first operating system program;
a second computer storing a server application program and a second operating system program; and
a data communication channel connecting the first computer to the second computer;
wherein:
the first application program is operative to issue a close file command that is applicable to a data file stored at the second computer;
the remote data access program module is operative to transmit the close file command to the server application program via the first and second operating system programs; and
the server application program is operative to execute the close file command with respect to the data file stored at the second computer.

19. A computer program product comprising:
a medium readable by a computer, the computer readable medium having program code adapted to:
issue a write command from an application program at a first computer, the write command being applicable to a data file stored at a second computer;
transmit the write command to an application program at the second computer; and
execute the write command with respect to the data file stored at the second computer.

20. A computer program product comprising:
a medium readable by a computer, the computer readable medium having program code adapted to:
issue from an application program at a first computer a command to read a selected portion of a data file stored at a second computer;
transmit the command to an application program at the second computer; and
execute the command with respect to the selected portion of the data file stored at the second computer.

21. A computer program product comprising:
a medium readable by a computer, the computer readable medium having program code adapted to:
issue an open file command from an application program at a first computer, the open file command being applicable to a data file stored at a second computer;
transmit the open file command to an application program at the second computer; and
execute the open file command with respect to the data file stored at the second computer.

22. A computer program product comprising:
a medium readable by a computer, the computer readable medium having program code adapted to:
issue a close file command from an application program at a first computer, the close file command being applicable to a data file stored at a second computer;
transmit the close file command to an application program at the second computer; and
execute the close file command with respect to the data file stored at the second computer.
